(19) United States
(12) Patent Application Publication
(10) Pub. No.: US 2020/0261785 A1
(43) Pub. Date: Aug. 20, 2020

(54) Matrix imprinting on action skill game pieces

(71) Applicant: Sweets Kendamas, LLC, Minneapolis, MN (US)

(72) Inventor: Gabriel Klemm, Minneapolis, MN (US)

(21) Appl. No.: 16/275,826

(22) Filed: Feb. 14, 2019

(51) Int. Cl. A63B 67/22; G06K 19/06; G06K 1/12

(52) U.S. Cl. CPC A63B 67/22; G06K 19/06037; A63B 2225/15; A63B 2209/00; G06K 1/121

(57) ABSTRACT

A game piece having computer readable data imprinted directly on a surface thereof, wherein the game piece is a kendama and the data is a matrix barcode readable via a camera. The data may be laser engraved on or pad printed on a surface of the kendama. The kendama is comprised of a hardwood and a hardwood surface of the kendama is altered to include the data thereon or therein such that the data is applied directly to the kendama without adhesive.

### BACKGROUND

The present invention relates the printing of a matrix barcode directly on a game piece. More specifically, the present invention relates to imprinting a QR Code™ directly on a kendama.

Barcodes, including two-dimensional or matrix barcodes, are generally provided on packaging associated with game pieces. The barcodes are printed on paperboard inserted within the plastic packaging for game pieces or are printed on the cardboard or paperboard boxes in which the game pieces are sold. The packaging is generally discarded once opened and the game piece taken out for use.

Game pieces sold without packaging generally have labels applied to the goods with a strong adhesive. The labels have a thickness which can interrupt use of the game pieces. Further, the labels can peel over time, eventually peeling off and leaving the sticky reside from the adhesive behind.

### SUMMARY

An aspect of the present disclosure relates to a game piece having machine or computer readable data printed directly on a surface thereof, wherein the game piece is a kendama and the data is a matrix barcode readable via a camera.

The data is imprinted on the surface of the game piece, and may be laser engraved on a surface of the kendama or pad printed on a surface of the kendama.

The kendama is comprised of a hardwood and a hardwood surface of the kendama is altered to include the data thereon or therein such that the data is applied directly to the kendama without adhesive. The data may be imprinted in a cup of the kendama.

The data is a matrix barcode that is configured for scanning with a smartphone and the barcode directs the smartphone to a selected website URL related to the game piece.

Another aspect of the present disclosure relates to a method of applying computer readable data to a game piece comprising providing a game piece wherein the game piece is a kendama and imprinting the computer readable data via laser engraving or pad printing to a surface of the kendama. The kendama may be a wooden kendama.

Another aspect of the present disclosure relates to embedding a selected website URL in the computer readable data and wherein scanning the computer readable data with a computer directs the computer to the website URL. The data can be a two-dimensional matrix barcode readable via a camera or scanner configured to convert the data to the website URL.

Yet another aspect of the present disclosure relates to a wooden kendama having computer readable matrix barcode directing to a web site URL imprinted directly on a surface of the wooden kendama. The matrix barcode may be imprinted in a cup of the kendama.

### BRIEF DESCRIPTION OF THE DRAWINGS

FIG. 1 is a perspective view of an action skill game piece having a two-dimensional barcode printed directly thereon.

### DETAILED DESCRIPTION

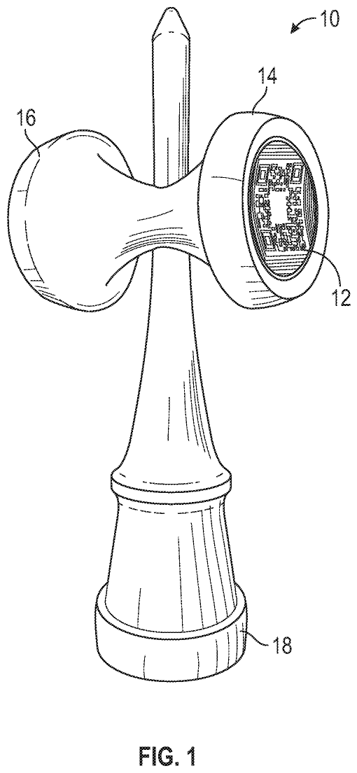

A game piece 10 having machine readable data 12 displayed directly thereon is illustrated in FIG. 1. The data 12 is imprinted, printed, engraved or otherwise applied directly to a surface of the game piece 10.

In one embodiment the game piece 10 is an action skill game piece. The game piece 10 may also be referred to as a “kendama,” which is a game piece for a cup-and-ball type game. In general, a kendama is a wooden game piece, the kendama comprising three cups, a spike, a wooden ball with a hole and a string. The cups are connected by a shaft. That is, two cups extend on opposite sides of the shaft and one cup extends from a terminal end of the shaft. The spike extends from a terminal end of the shaft opposite the third cup. The string generally connects the ball to the shaft.

The kendamas are generally comprised of hardwood and like materials, although it is contemplated that in the embodiments described herein the kendamas may be comprised of hard resins such as various plastics and other composite materials. The ball may be comprised of the same material as the cups and shaft or may be comprised of a different material. Kendamas are action skill toys that benefit a user's hand-eye coordination and reflexes as well as teach the user patience and determination. For example, the toy can be used in various manners and to carry out various tricks.

As illustrated in FIG. 1, machine readable optical data 12 such as a matrix barcode or two-dimensional barcode, including those commonly referred to as QR Codes™ are provided directly on the game piece 10. In this embodiment, the game piece is a kendama 10. The machine readable optical data 12 can be read by an imaging device such as a camera and may contain data for a website URL, locator, identifier, or tracker that points to a website for allowing the user to track game piece usage, train, learn tricks, register and customize their kendama experience.

In one embodiment the data 12 is printed on or in a first 14, second 16, and/or third cup 18 of the kendama 10. The data 12 may also be printed on the shaft or any other surface of the kendama 10. The data 12 is printed or imprinted directly on a surface the kendama 10 itself, rather than on a label, paperboard packaging associated with the kendama during shipping, or pre-use packaging. That is, the data 12 remains on the kendama 10 during use of the kendama 10.

The data 12 may be applied directly to the kendama via engraving, laser engraving, pad printing, tampography, direct pressing, and other methods wherein the two-dimensional data 12 is applied directly and permanently to the surface of the three-dimensional game piece 10. As illustrated herein, the data 12 is imprinted in a cup of the kendama, that is, the data 12 is imprinted on a curved surface of the kendama 10. The embodiments described eliminate the use of stickers or adhesive labels applied to the game piece 10 and the data can be applied without adhesives between the game piece 10 and the data 12. As such, the data 12 is its own label that is integrated into a surface of the game piece 10 itself.

The game piece 10 and data 12 printed or otherwise engraved directly in or on the surface of game piece 10 can be scanned by a user's smartphone, mobile device or similar equipment having a camera or other device for reading and/or scanning optical data such as a QR code or similar grid. Scanning the code with a smartphone or other camera may convert the data to a selected website URL, allowing the user to access content for enhancing game play experience and/or for registering their game piece 10 for expanding the user experience associated with the game piece 10. The data 12 on the game piece 10 can be scanned repeatedly before, during and after use of the game piece 10 and the data 12 applied to the game piece 10 does not inhibit or otherwise affect game play as there is no adhesive residue or other physical label layer added on top of the game piece 10. Further, since the data 12 is engraved, imprinted, or otherwise applied to the surface of the game piece 10 there is no risk of losing the data 12 for the game piece 10.

One embodiment of a method of applying machine readable data 12 to the surface of the game piece 10 includes selecting a matrix bar code where the selected barcode is then applied directly to a selected surface of a game piece. The bar code may be applied via laser engraving or pad printing on the selected surface of the game piece 10.

Once obtained by a user, the data 12 on the game piece 10 can be scanned and the user thus pairs their game piece 10 with a website of the manufacturer or a website for game piece which may include interactive content accessible though the website the data 12 directs the user to for enhancing their user game play experience. The enhancement may include, but are not limited to, tutorials for learning tricks the game piece is capable of performing, tracking user play and improvement, inputting of user stats and comparing stats with other players, interacting with other users of the game piece, receiving alerts, news and updates related to the game piece and additional types of information.

Although the present disclosure has been described with reference to preferred embodiments, workers skilled in the art will recognize that changes may be made in form and detail without departing from the spirit and scope of the disclosure.

1. A game piece having computer readable data printed directly and permanently on a surface thereof and remains on the game piece during use of the game piece, wherein the game piece is a kendama and the data is a matrix barcode readable via a camera.

2. The game piece of claim 1, wherein the data is laser engraved on a surface of the kendama.

3. The game piece of claim 1, wherein the data is pad printed on a surface of the kendama.

4. The game piece of claim 1, wherein the kendama is comprised of a hardwood and a hardwood surface of the kendama is altered to include the data thereon or therein such that the data is applied directly to the kendama without adhesive.

5. The game piece of claim 1, wherein the data is imprinted on a curved surface of the kendama.

6. The game piece of claim 1, wherein the matrix barcode is configured for scanning with a smartphone and the data therein directs the smartphone to a selected website URL related to the game piece.

7. A method of applying computer readable data to a game piece comprising:
providing a game piece wherein the game piece is a kendama; and
applying the computer readable data via one of laser engraving or pad printing directly and permanently on a surface of the kendama,
wherein the data is a matrix barcode readable via a camera and the data remains on the game
piece during use of the game piece.

8. The method of claim 7, wherein the kendama is comprised of a hardwood.

9. The method of claim 7, wherein the data is applied directly to the game piece without adhesive.

10. The method of claim 7 and further comprising embedding a selected website URL in the computer readable data and scanning the computer readable data with a computer directs the computer to the website URL.

11. The method of claim 7, wherein the data is a two-dimensional matrix barcode readable via a camera or scanner configured to convert the data to a website URL.

12. A wooden kendama having computer readable matrix barcode directing to a website URL imprinted directly on a surface of the wooden kendama.

13. The kendama of claim 1, wherein the matrix barcode is imprinted inside a cup of the kendama.
